(19) United States
(12) Patent Application Publication
(10) Pub. No.: US 2006/0258335 A1
(43) Pub. Date: Nov. 16, 2006

(54) MOBILE HANDSET CAPABLE OF TRANSMITTING PRESET VOICE MESSAGE AND RELATED METHOD THEREOF

(76) Inventor: Sheng-En Yeh, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/162,600

(22) Filed: Sep. 16, 2005

(30) Foreign Application Priority Data
May 13, 2005 (CN) 200510070481.4

(51) Int. Cl. H04M 11/10; H04L 12/58; H04Q 7/22

(52) U.S. Cl. 455/413; 455/412.1

(57) ABSTRACT

The invention relates to a mobile handset capable of transmitting a preset voice message and a related method thereof. The method includes receiving an incoming call; establishing a communication channel corresponding to the incoming call and feeding back the preset voice message through the communication channel; and terminating the communication channel.

### BACKGROUND OF THE INVENTION

1. Field of the Invention

The present invention relates to a mobile handset and a related method, and more specifically, to a mobile handset capable of transmitting a preset voice message and a related method.

2. Description of the Prior Art

In the modern information society with highly developed communication systems, people popularly utilize convenient, portable, and handy mobile phones in their daily communications. People can exchange information, share experiences, and communicate with each other by convenient mobile phones whenever and wherever. Because mobile phones are increasingly popular, telecommunication service providers and mobile phone manufacturers develop easier and simpler operations for the control of mobile phones. Additionally, the providers and manufacturers provide users with more user-friendly communication services.

A common telecommunication service is taken for example. When a user A dials a phone number of a user B's mobile handset, if the user B does not answer, the telecommunication service provider then informs the user A to enter a voice mailbox. The voice mailbox will then play an announcement of a preset voice message requesting the user A to leave a message in the voice mailbox. Alternatively, the telecommunication service provider may play a voice message recorded by the user B and that has been previously stored in a switch of the telecommunication service provider. This message is to inform the user A that it is not convenient for the user B to answer the phone call. However, one of the disadvantages of the above-mentioned conventional methods is that it is not convenient for the user B to modify the self-recorded voice message. Additionally, general telecommunication service providers only offer a single personally selected voice message for a user. Therefore, the mobile handset cannot play different voice messages respectively according to different caller numbers. Additionally, because the process of entering the voice mailbox requires a long time, the caller will pay additional money for using this service.

### SUMMARY OF THE INVENTION

One of the objectives of the claimed invention is therefore to provide a mobile handset and a method for selectively connecting the mobile handset with an incoming call automatically and playing a preset voice message to solve the above-mentioned problems.

In addition, another one of the objectives of the claimed invention is therefore to provide a mobile handset and a method for selectively connecting the mobile handset with an incoming call automatically and feeding back (i.e., responding with) a preset voice message corresponding to the phone number of the incoming call. According to the claimed invention, a method applied to a mobile handset for transmitting a preset voice message is disclosed. The method comprises: receiving an incoming call; establishing a communication channel corresponding to the incoming call and feeding back the preset voice message through the communication channel; and terminating the communication channel.

According to the claimed invention, a method applied to a telephone apparatus for transmitting a preset voice message is disclosed. The method comprises: receiving an incoming call; establishing a communication channel corresponding to the incoming call and feeding back the preset voice message corresponding to a preset phone number through the communication channel if a phone number of the incoming call corresponds to the preset phone number; and terminating the communication channel.

According to the claimed invention, a mobile handset is disclosed. The mobile handset comprises: a memory unit for storing a preset voice message; and a control unit, coupled to the memory unit, for establishing a communication channel corresponding to an incoming call and feeding back the preset voice message through the communication channel.

According to the claimed invention, a telephone apparatus is disclosed. The telephone apparatus comprises: a memory unit for storing a preset voice message and a corresponding preset phone number; and a control unit, coupled to the memory unit, for establishing a communication channel corresponding to an incoming call and feeding back the preset voice message through the communication channel when the telephone apparatus receives the incoming call and a phone number of the incoming call corresponds to the preset phone number.

Therefore, the mobile handset can selectively and automatically connect itself with an incoming call and automatically play a preset voice message for a caller of the incoming call after the incoming call has been received and identified. Finally, the mobile handset can play different preset voice messages according to phone numbers of different incoming calls.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a first embodiment of the method for transmitting a preset voice message according to the present invention.

FIG. 2 is a flowchart of a second embodiment of the method for transmitting a preset voice message according to the present invention.

FIG. 3 is a functional block diagram of a preferred embodiment of the telephone apparatus 300 for transmitting a preset voice message according to the present invention.

### DETAILED DESCRIPTION

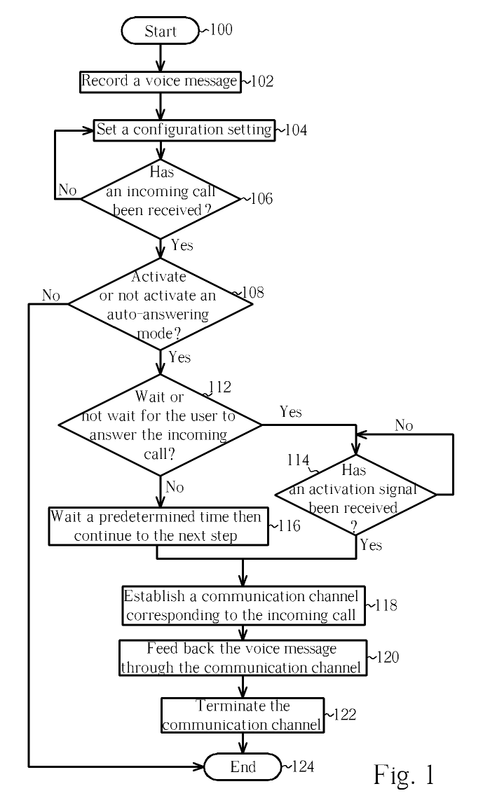

Please refer to FIG. 1. FIG. 1 is a flowchart of a first embodiment of the method for transmitting a preset voice message according to the present invention. The present embodiment applied to a mobile handset comprises the following steps:

Step 100: Start.

Step 102: Record a voice message utilizing a mobile handset and store the voice message in a memory unit of the mobile handset.

Step 104: Set a configuration setting of the mobile handset.

Step 106: Has an incoming call been received? If so, proceed to step 108; otherwise, repeat step 106.

Step 108: Activate or not activate an auto-answering mode according to the configuration setting? If so, proceed to step 112; otherwise, proceed to step 124.

Step 112: Wait or not wait for the user to answer the incoming call according to the configuration setting? If so, proceed to step 114; otherwise, proceed to step 116.

Step 114: Has an activation signal been received? If so, proceed to step 118; otherwise, repeat step 114.

Step 116: Wait a predetermined time then continue to the next step.

Step 118: Establish a communication channel corresponding to the incoming call.

Step 120: Feed back the voice message through the communication channel.

Step 122: Terminate the communication channel.

Step 124: End.

Please refer to FIG. 1. A user who utilizes the mobile handset must record a voice message (step 102), and set a configuration setting to be stored in the mobile handset (step 104). The configuration setting is utilized for indicating when the mobile handset is in an auto-answering mode or not in an auto-answering mode. The configuration setting is also utilized for storing settings related to the auto-answering mode, such as: a predetermined time period for waiting before the mobile handset will automatically answer the phone call, a decision to wait or not wait for the user to trigger the mobile handset to automatically answer the incoming call, and so on. When the mobile handset receives an incoming call, it is necessary to determine if the mobile handset is currently in an auto-answering mode according to the above-mentioned configuration setting (step 108). If the mobile handset is currently in an auto-answering mode, a decision of waiting or not waiting for the user to trigger the mobile handset causing it to automatically answer the incoming call needs to be made according to the configuration setting (step 112). If it is necessary to wait for the user to trigger the mobile handset causing it to answer the incoming call, which means it is necessary for the mobile handset to wait until an activation signal is received (i.e., the user presses a “connect” key or opens the handset's clamshell case) to connect itself with the incoming call (i.e., to establish a communication channel corresponding to the incoming call) and then feed back the voice message to the caller. If it is not necessary to wait for the user to trigger the mobile handset causing it to answer the incoming call, then after a predetermined time period has elapsed, the incoming call is answered automatically and a voice message is announced to the caller. Please note that in the present embodiment, the user can also set the predetermined time period to be 0 seconds. In this way, the mobile handset immediately connects itself with the incoming call and does not play any ring sound. After the mobile handset is finished playing the voice message, the mobile handset automatically terminates the connection (step 124), and the method is ended.

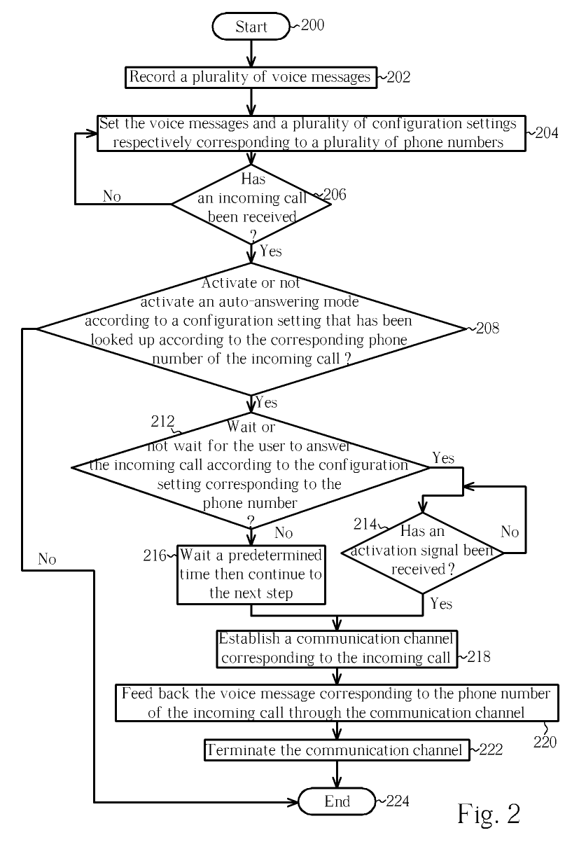

Please refer to FIG. 2. FIG. 2 is a flowchart of a second embodiment of the method for transmitting a preset voice message according to the present invention. The present embodiment can be applied to a telephone apparatus with memory functions. The detailed steps are described as follows:

Step 200: Start.

Step 202: Record a plurality of voice messages utilizing a telephone apparatus and store the voice messages in a memory unit of the telephone apparatus.

Step 204: Set the voice messages and a plurality of configuration settings respectively corresponding to a plurality of phone numbers.

Step 206: Has an incoming call been received? If so, proceed to step 208; otherwise, repeat step 206.

Step 208: Activate or not activate an auto-answering mode according to a configuration setting that has been looked up according to the corresponding phone number of the incoming call? If so, proceed to step 212; otherwise, proceed to step 224.

Step 212: Wait or not wait for the user to answer the incoming call according to the configuration setting corresponding to the phone number? If so, proceed to step 214; otherwise, proceed to step 216.

Step 214: Has an activation signal been received? If so, proceed to step 218; otherwise, repeat step 214.

Step 216: Wait a predetermined time then continue to the next step.

Step 218: Establish a communication channel corresponding to the incoming call.

Step 220: Feed back the voice message corresponding to the phone number of the incoming call through the communication channel.

Step 222: Terminate the communication channel.

Step 224: End.

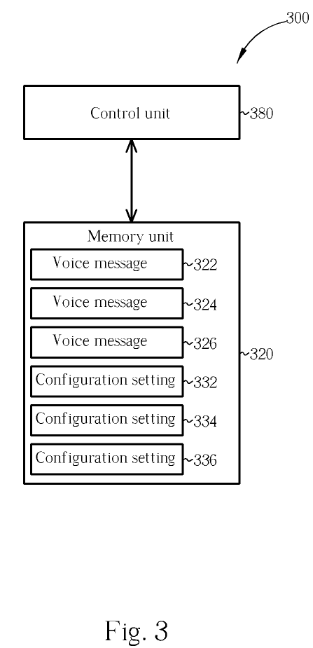

The greatest major difference between the present embodiment and the embodiment of the FIG. 1 is that in the present embodiment, the phone numbers of different incoming calls (i.e., different caller numbers) may correspond to different configuration settings and different voice messages, respectively. Hence, the user can set different voice messages corresponding to the phone numbers of the different incoming calls, or set a specific phone number of an annoying incoming call to correspond to an auto-answering mode to save time for answering the annoying incoming call. In addition, according to the method of the present invention, the user can modify the configuration setting according to the user's current environment or availability; for example, if the user may be temporarily away from the mobile handset, the user can preset the predetermined time period to be 5 seconds. In this way, if during 5 seconds no one answers an incoming call, a voice message feedback will inform the caller that the user of the mobile handset is presently away from her own mobile handset and please redial the phone number later. If the user is holding a meeting, he/she can set the predetermined time period to be 0 seconds. In this way, if someone makes a phone call to the user, the user's mobile handset will receive the incoming call and immediately answer the incoming call by responding with the voice message. Therefore, the meeting will not be interrupted by the ring sound made by the mobile handset. Please refer to FIG. 3. FIG. 3 is a functional block diagram of a preferred embodiment of the telephone apparatus 300 for transmitting a preset voice message according to the present invention. The telephone apparatus 300 is a typical mobile handset, or a digital telephone with memory functions and decision units. The telephone apparatus 300 comprises a memory unit 320 and a control unit 380. The memory unit 320 is utilized for recording a plurality of voice messages 322, 324, 326 and a plurality of configuration settings 332, 334, 336. After the telephone apparatus 300 receives an incoming call, the control unit 380 will search the memory unit 320 for a configuration setting and a voice message corresponding to a phone number of the incoming call. Assume that the phone number of the incoming call corresponds to the configuration setting 332 and the voice message 322. The control unit 380 decides the time at which to establish a communication channel corresponding to the incoming call according to the configuration setting 332, and then the control unit 380 responds to the phone call with the voice message 322 for the caller (who makes the incoming call) through the communication channel. The detailed description of the operation flow of the control unit 380 is omitted for brevity, and FIG. 1 and FIG. 2 are provided as references for the detailed description of the operation flow of the control unit 380.

In contrast to the related art, the mobile handset according to the present invention can selectively and automatically connect itself with the incoming call and automatically answer the incoming call by playing a preset voice message for the caller after the incoming call has been received. In addition, the mobile handset of the present invention can utilize different configuration settings according to different phone numbers, and play different voice messages corresponding to different phone numbers. In this way, the operation method of the mobile handset has more flexibility.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method applied to a mobile handset for transmitting a preset voice message, comprising:
receiving an incoming call;
establishing a communication channel corresponding to the incoming call and feeding back the preset voice message through the communication channel; and
terminating the communication channel.

2. The method of claim 1, further comprising:
setting a caller number corresponding to the preset voice message;
wherein the step of establishing the communication channel and feeding back the preset voice message is executed when the incoming call corresponds to the caller number.

3. The method of claim 1, wherein the step of establishing the communication channel and feeding back the preset voice message is executed immediately after the incoming call has been received.

4. The method of claim 1, wherein the step of establishing the communication channel and feeding back the preset voice message is executed after the incoming call has been received and then a predetermined time period has elapsed.

5. The method of claim 1, wherein the step of establishing the communication channel and feeding back the preset voice message is executed after the incoming call and an activation signal have been received.

6. A mobile handset, comprising:
a memory unit for storing a preset voice message; and
a control unit, coupled to the memory unit, for establishing a communication channel corresponding to an incoming call and feeding back the preset voice message through the communication channel.

7. The mobile handset of claim 6, wherein the memory unit further stores a caller number corresponding to the preset voice message, and the control unit plays the preset voice message when the incoming call corresponds to the caller number.

8. The mobile handset of claim 6, wherein the control unit establishes the communication channel and feeds back the preset voice message immediately after the incoming call has been received.

9. The mobile handset of claim 6, wherein the control unit establishes the communication channel and feeds back the preset voice message after the incoming call has been received and then a predetermined time period has elapsed.

10. The mobile handset of claim 6, wherein the control unit establishes the communication channel and feeds back the preset voice message after the incoming call and an activation signal have been received.

11. A telephone apparatus, comprising:
a memory unit for storing a preset voice message and a corresponding preset phone number; and
a control unit, coupled to the memory unit, for establishing a communication channel corresponding to an incoming call and feeding back the preset voice message through the communication channel when a phone number of the incoming call corresponds to the preset phone number.

12. The telephone apparatus of claim 11, wherein the control unit establishes the communication channel and feeds back the preset voice message immediately after the incoming call has been received.

13. The telephone apparatus of claim 11, wherein the control unit establishes the communication channel and feeds back the preset voice message after the incoming call has been received and then a predetermined time period has elapsed.

14. The telephone apparatus of claim 11, wherein the control unit establishes the communication channel and feeds back the preset voice message after the incoming call and an activation signal have been received.
